(19) United States
(12) Patent Application Publication
(10) Pub. No.: US 2009/0272319 A1
(43) Pub. Date: Nov. 5, 2009

(54) Apparatus For Hot-Dip Coating Of A Metal Strand

(76) Inventors: Holger Behrens, Erkrath (DE); Rolf Brisberger, Spielberg (AT); Hans-Georg Hartung, Pulheim (DE); Ruediger Zerbe, Neuss (DE)

Correspondence Address: ABELMAN, FRAYNE & SCHWAB, 666 THIRD AVENUE, 10TH FLOOR, NEW YORK, NY, 10017, US

(21) Appl. No.: 11/988,155

(22) PCT Filed: Jun. 28, 2006
(86) PCT No.: PCT/EP2006/006236

§ 371 Date: Jan. 26, 2009

(30) Foreign Application Priority Data
Jul. 1, 2005 (DE) 10 2005 030 766.3

(51) Int. Cl. B05C 3/02

(52) U.S. Cl. 118/623

(57) ABSTRACT

The present invention relates to an apparatus for hot-dip coating of a metal strand, in particular a steel strip, in which the metal strand (1) passes vertically through a vessel containing a melted coating metal (2) and an upstream guide channel (4) in a region of which at least two inductors (5) for producing an electromagnetic field are arranged on both sides of the metal strand (1) for retaining the coating metal (2) in the vessel and an increased volume of the coating metal (2) is available in at least one section (4a).

For killing the coating metal bath, according to the invention, the increased volume is provided in a region of the magnetic field of the inductors (5).

The present invention relates to an apparatus for hot-dip coating of a metal strand, in particular a steel strip, in which the metal strand passes vertically through a vessel containing a melted coating metal and an upstream guide channel in a region of which at least two inductors for producing an electromagnetic field are arranged on both sides of the metal strand for retaining the coating metal in the vessel, and an increased volume of the coating metal is available in at least one section.

Such an apparatus constitutes subject matter of an older German application (103 30 656.0 of Jul. 8, 2004). The object of the invention, which is set forth there and forms the basis of the preamble, is to provide an apparatus for a hot-dip coating of a metal strand that would overcome certain drawbacks of the state of the art mentioned there, in particular, of EP 0 673 444 B1, WO 96/03533, and JP 5086446. It should be insured that the immersion bath remains calm when an electromagnetic seal is used, whereby the quality of coating should be increased. It was established that the bath surface of the coating metal remains relatively troubled, which is transmitted back to the electromagnetic forces via the magnetic seal. However, the premise of obtaining of a precise coating thickness is a calm metal bath surface.

To this end, according to an older proposal, it is contemplated, among others, to provide, either between the guide channel and the bottom of the vessel or in the guide channel itself, a widening of the cross-section into which the coating metal can penetrate from above. This widening of the cross-section leads, in the last named embodiment to an increased volume of the coating metal in the region of the guide channel, and this forms a starting point of the present invention.

The object of the invention is to develop further measures such that the immersion bath remains calm with the use of the electromagnetic seal in order to increase the quality of the coating.

The object of the invention is achieved, according to the invention, by providing the increased volume in the region of the magnetic field of the inductors.

In the older patent application, the increased volume of the coating metal is located either in the bottom region of the vessel or in the guide channel, but always above the inductors. Thus, the increased volume is predominantly located outside of the active magnetic field of the inductors. According to the invention, contrary to this, the increased volume is purposefully placed in the region of the magnetic field of the inductors, which results in that the region with the increased volume counteracts the influence of the magnetic field.

In an advantageous embodiment of the invention, the increased volume is provided in the region from the upper half to upper third of the inductors.

The present invention shows different measures for provision of the increased volume. In a first embodiment, it can be contemplated to form the increased volume by widening upward the width of the wall of the guide channel in a funnel-shaped manner. This embodiment can be made or retrofitted with particularly low costs when the guide channel is formed as a separate and, therefore, exchangeable tube member.

The same advantages has the second embodiment in which it is contemplated to provide the increased volume by widening sidewise in a step-shaped manner the width of the guide channel wall.

Finally, according to the modification of the second embodiment, it is contemplated to arrange within the widening and in the vicinity of the upper edge of the inductors, a cut-off wall. The cut-off wall can lead to further killing of the metal bath or its surface.

According to a further development of the second embodiment, the cut-off wall can be formed in a particular manner, so that the lower or upper or both edges of the cut-off wall is (are) beveled, being provided with at least one bevel, is (are) formed cone-shaped, or is (are) rounded.

It further can be provided that the cut-off wall is electrically conductive on non-conductive. As a material, here, e.g., ceramics or another material, which is resistant to temperatures or aggressiveness of the melted coating metal, can be used.

In a third embodiment, it is provided that the increased volume is produced by a sidewise swelling of the wall of the guide channel. Here, also, retrofitting by exchange of the guide channel is possible with low costs.

The fourth embodiment of the invention contemplates, for increase of the volume, to produce the increased volume by sidewise feeding of an additional coating metal instead of or in addition to a shielded cross-sectional increase.

Here, the additional volume flow of the coating metal into the guide channel takes care for eventual, also additional increase of volume.

According to the modification of the fourth embodiment, an effective increase of volume is achieved by sidewise feeding via at least two tubes which, advantageously, extend through the narrow sides of a rectangular guide channel.

With the proposed measures, it is achieved that the upper surface of the bath of the coating metal inside the vessel remains relatively calm so that a high quality of the dip-coating is achieved.

The drawings show embodiments of the invention.

It is shown:

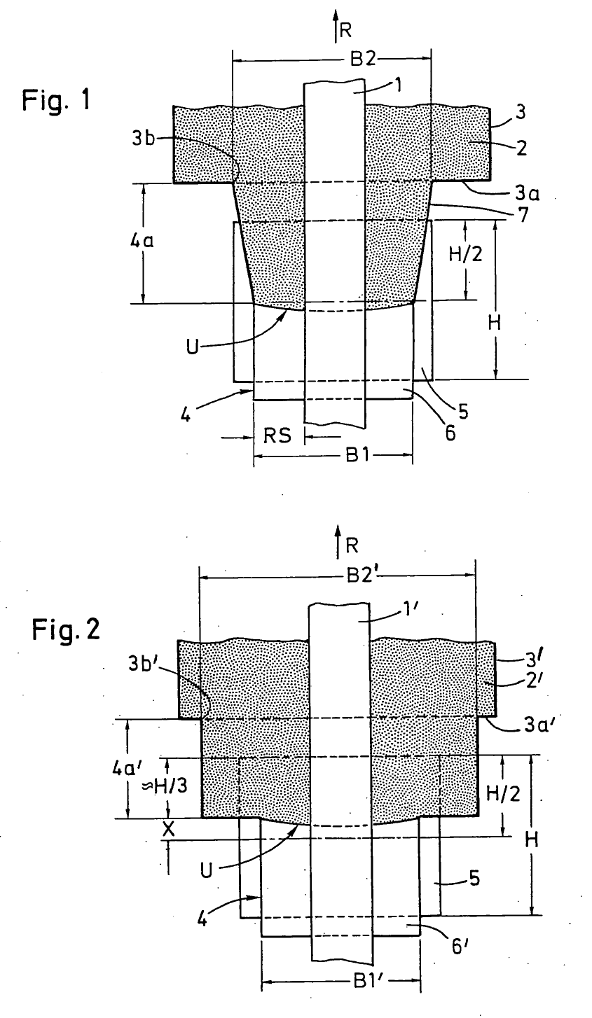

FIG. 1 a schematic view of a lower part of an apparatus for hot-dip coating with a metal strand passing therethrough in the middle section along the metal strand, wherein simply the region of the bottom of the vessel for the coating metal and upwardly extending guide channel that adjoins the vessel and is provided with inductors, are shown;

FIG. 2 a second embodiment of the invention in form of a step-shaped sidewise widening of the guide channel;

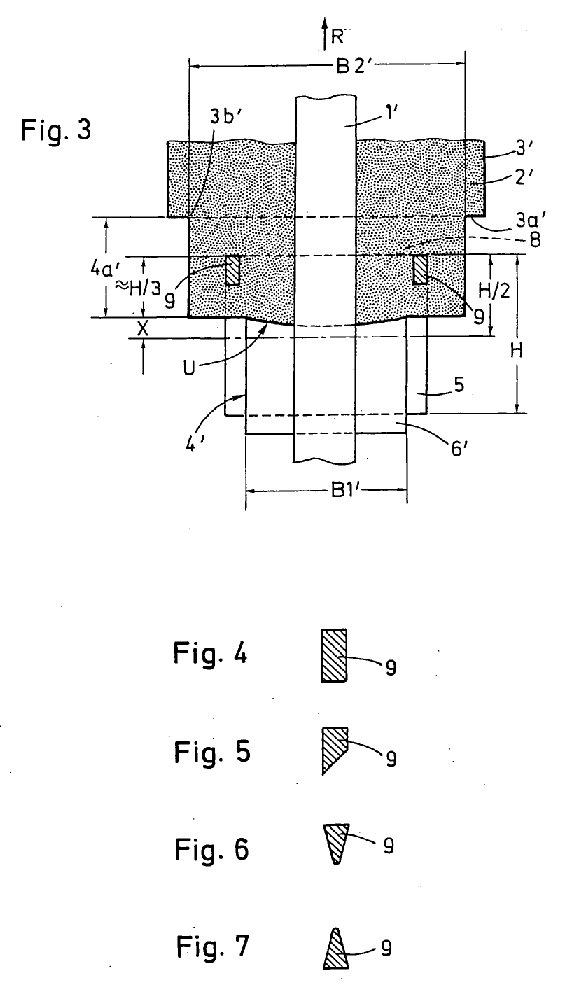

FIG. 3 a third embodiment of the invention, according to FIG. 1, with a cut-off wall;

FIG. 4 a first shape of the cross-section of the cut-off wall in FIG. 3;

FIG. 5 a second shape of the cross-section of the cut-off wall in FIG. 3;

FIG. 6 a third shape of the cross-section of the cut of the cut-off wall in FIG. 3;

FIG. 7 a fourth shape of the cut-off wall in FIG. 3;

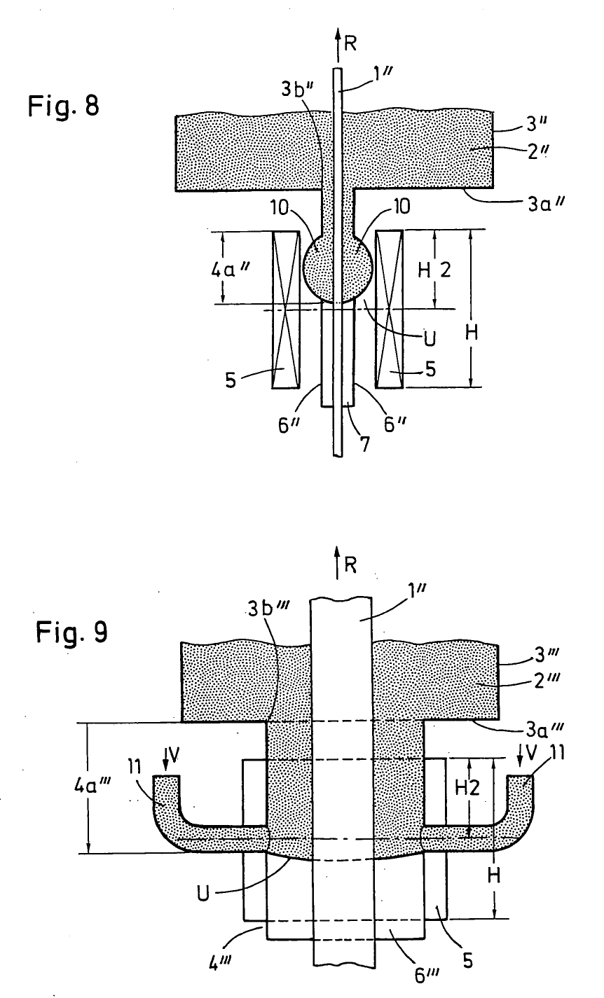

FIG. 8 a fourth embodiment of the invention, according to FIG. 1, though in the middle section transverse to the metal strand, in form of a swelling; and

FIG. 9 a fifth embodiment of the invention, according to FIG. 1, however, with a sidewise feeding of the coating metal in the guide channel.

With an apparatus shown in FIG. 1 only partially, a to-be-coated metal strand 1 in form of a steel strip is pulled off vertically, preferably upwardly in the feeding direction R through a melted coating metal 2. The coating metal 2 can be, in particular, zinc or aluminum and is stored in a suitable, shown only schematically, vessel 3 under an air seal.

In the bottom 3 a of the vessel 3, there is formed a through-opening 3b for the metal strand 1. A guide channel 4 in form, in principle, of a small rectangular tube adjoins the through-opening 3b at the bottom 3a and extends therefrom downwardly. The strip-shaped metal strand passes the guide channel 4 with an all-side clearance, whereby the remaining, free cross-section of the guide channel 4 in form of an annular gap RS is filled with a coating metal 2 over a certain vertical path, so that the metal strand 1 is surrounded by the coating metal 2 in the upper region 4a of the channel 4. Thus, the coating metal 2 forms, in the upper region 4a, a kind of a liquid annular seal that fills the annular gap RS downwardly up to U.

To insure the sealing action of this annular seal, i.e., for a long-lasting reliable sealing of the annular gap RS, there are arranged, in the guide channel 4, on both sides of a longitudinal wall 6 of the guide channel 4, downwardly extending inductors 5. The inductors 5 produce a strong magnetic field in the region of the guide channel 4 and which counteracts the gravity force of the annular coating metal 2 there to such an extent that the coating metal cannot run out from the guide channel 4 downwardly, but rather remains essentially stationary at point U.

The clearance, which is shown in FIG. 1, and thereby the annular gap RS are increased by 1.5 times and are not shown to a scale. The volume of the annular coating metal 2 in the upper region 4a of the guide channel 4, which acts as an annular seal, can in reality be very small.

The type of the inductors 5 and their action and the use of correction coils (not shown), and further features of the apparatus are described in detail in the above-mentioned older German application.

In order to insure kill of the bath surface in the vessel, an enlarged volume of the coating material 2 is provided in the region of the magnetic field of the inductors 5, in particular immediately adjacent to the inductors 5.

To this end, in the first embodiment of the invention shown in FIG. 1, the upper region 4a of the guide channel 4, which opens into the through-opening 3b in the bottom 3 expands as a funnel, with the lower width B1 of the longitudinal wall 6 increasing upwardly to the width B2. A narrow wall 7 is inclined to a vertical at an acute angle that amounts to about from 1° to 15°.

The widening of the longitudinal wall 6 of the guide channel 4 and, thereby, of the region 4b starts about at a half height H/2 of the height H of inductors 5 and extends up to the complete height H, passing then in longitudinal sides of the rectangular opening 3b in bottom 3a of the vessel 3. The volume of the coating material increases in the region of the annular gap RS and actually on the narrow transverse sides of the metal strand 1.

With the above-described funnel-shaped formation of the guide channel 4 and its spacial arrangement relative to the magnetic field of the metal strand 1, current turbulences in the melted coating metal 2, which are caused by the magnetic field, are substantially prevented, and the melt bath is killed, in particular on its upper surface.

In the following figures, the same parts are designated with the same reference numerals with an index. FIG. 2 shows a second embodiment of the invention. Here, the increased volume of the coating metal 2 is achieved with a step-shaped widening region 4a′ of the channel 4′ to this end, the longitudinal wall 6′ increases from a lower width B1 to an upper width B2 in a step-shaped manner, forming thereby a step-shaped region 4a′ opening into a through-opening 3b′ in the bottom 3a′.

The step-shaped widening of the longitudinal walls 6′ of the guide channel 4′ and, thereby, of the region 4a′ starts below at a distance x with a half height 4/2 and, thus, in about the upper one/third H/3 of the height H, somewhat at half height H/2 of the height H of the inductors 5, and extends over the complete height H out, in order to then pass in longitudinal sides of the rectangular through-opening 3b′ in the bottom 3a′ of the vessel 3′.

The operation of the step-shaped region 4a′ and its arrangement are the same as of the funnel-shaped formation of the region 4a.

FIG. 3 shows a third embodiment of the invention. It corresponds substantially to the embodiment of FIG. 2 up to the following addition:

Within the section 4a′ and in the vicinity of the upper inductor edges 8, there is arranged, respectively, a cut-off wall 9. The cut-off wall 9 serves for flow steering and bath killing, in particular, in combination, with measures described in detail in the older patent application.

FIGS. 4-7 show possible cross-sections of the cut-off walls 9, 9′, 9″ and 9′″. The cut-off walls 9-9′″ can be formed of a suitable electrically conductive or non-conductive material, in particular, of metal or ceramics, and have an angular cross-section, such as rectangular, formed with a single or double bevel, in particular, having an angle from 15° to 60° to a vertical, or rounded in form of a cone or funnel extending upwardly and/or downwardly and, enclosing an angle of from 15° to 60°.

FIG. 8 shows the fourth embodiment of the invention, according to FIG. 1, but in the middle section transverse to the metal strand 1 Here, the guide channel 4″, at the height of the upper half H/2 of the height H of inductors 5, a sidewise, somewhat spherical swelling 10 of the longitudinal walls 6″ and, thus, there, the volume of the coating metal 2 increases in the annular gap, and actually, on the longitudinal sides of the metal strand 1.

FIG. 9 shows the fifth embodiment of the invention, according to FIG. 1, but with a sidewise feeding of the coating material into the guide channel 4′″. The feeding takes place via two tubes 11 which open somewhat horizontally in the guide channel 4′″ at the half height H/2 of the height H of the inductors 5, increasing there the volume of the coating material 2′″ practically over the entire annular gap. The advantageous effect of the sidewise feeding via the tubes 11 and their arrangement is the same as that of the funnel-shaped formation and the arrangement of the region 4a described with reference to FIG. 1.

As it has already been intimated different, above-described features of the invention can be combined with each other and also with those proposed in the older patent application.

### LIST OF REFERENCE CHARACTERS

1 Metal strand
1′ Metal strand
1″ Metal strand
1′″ Metal strand
2 Coating metal
2′ Coating metal
2″ Coating metal
2″″ Coating metal
3 Vessel
3′ Vessel
3″ Vessel
3′″ Vessel
3a Bottom
3a′ Bottom
3a″ Bottom
3a′″ Bottom
3b Through-opening
3b′ Through-opening
3b″ Through-opening
3b′″ Through-opening
4 Guide channel
4′ Guide channel
4″ Guide channel
4′″ Guide channel
4a Region
4a′ Region
4a″ Region
4a′″ Region
5 Inductor
6 Longitudinal wall
6′ Longitudinal wall
6″ Longitudinal wall
6′″ Longitudinal wall
7 Transverse wall
8 Upper inductor edge
9 Cut-off wall
10 Swelling
11 Tube
B1 Lower width
B1′ Lower width
B2 Upper width
B2′ Upper width
H Height
H/2 Half-height
H/3 Third of the height
R Feeding direction
RS Annular gap
U Lower end
X Distance

1-8. (canceled)

9. An apparatus according to claim 12,
characterized in that
the increased volume is produced by sidewise feeding of an additional coating metal 2′″).

10. An apparatus according to claim 9,
characterized in that
for the sidewise feeding at least two tubes (11) are provided.

11. An apparatus according to claim 10,
characterized in that
the guide channel (4′″) has a rectangular cross-section, and at least one tube (11) opens on each narrow side.

12. An apparatus for hot-dip coating of a metal strand (1, 1′, 1″, 1′″), in particular a steel strip, in which the metal strand (1, 1′, 1″, 1′″) passes vertically through a vessel (3, 3′, 3″, 3′″) containing a melted coating metal (2, 2′, 2″, 2′″) and an upstream guide channel (4, 4′, 4″, 4′″) in a region of which at least two inductors (5) for producing an electromagnetic field are arranged on both sides of the metal strand (1, 1′, 1″, 1′″) for retaining the coating metal (2, 2′, 2″, 2′″) in the vessel (3, 3′, 3″, 3′″), and an increased volume of the coating metal (2, 2′, 2″, 2′″) is available in a region of an upper half (H/2) to an upper third (H/3) of the inductors (5) and their magnetic field,
characterized in that
the increased volume is produced by a sidewise swelling of the wall (6″) of the guide channel (4′).
